(19) United States
(12) Patent Application Publication
(10) Pub. No.: US 2007/0162377 A1
(43) Pub. Date: Jul. 12, 2007

(54) System and method for an online exchange of private data

(75) Inventor: Jason S. Williams, Braselton, GA (US)

Correspondence Address: W. Scott Petty, Esq.;KING & SPALDING LLP, 45th Floor, 191 Peachtree Street, N.E., Atlanta, GA, 30303, US

(73) Assignee: Credigy Technologies, Inc., Las Vegas, NV (US)

(21) Appl. No.: 11/317,210

(22) Filed: Dec. 23, 2005

(51) Int. Cl. G06Q 40/00

(52) U.S. Cl. 705/37

(57) ABSTRACT

Based on the small world theory of networking, the present invention provides access to a previously unavailable source of private data, necessary for commerce, by facilitating the sale of private data from members of the general public. For example, the seeker of private data, such as consumer information, submits a data request to an online portal system. The request submission includes legal representations stating the legally permissible purpose for seeking the information. The portal system may display the data request to registered data providers, based on their demographic data. The system facilitates the exchange between the data buyer and the data provider. A payment invoice can be generated and electronically presented by the portal system. The payment may be electronically debited from the designated account of a data. In addition, a portion of such funds may be retained by the portal entity.

### FIELD OF THE INVENTION

The invention relates generally to a data exchanging arrangement with a centralized exchange entity accessible over a computer network, and more particularly to a centralized entity on the Internet facilitating the purchase and sale of private data while maintaining compliance with applicable law.

### BACKGROUND OF THE INVENTION

In the modem marketplace, private third party electronic data is the raw material for a substantial, and growing, percentage of both commercial and non-commercial processes. Private data, such as a consumer's identity information, financial information, health care information, insurance information, life style information and law enforcement records, is extremely valuable. Such data enables efficient automation of commercial and non-commercial processes while increasing process integrity through the integration of complex business rules, which act on such data. Like anything of value, such data is often misappropriated for criminal purposes or utilized for unintended or non-compliant uses. At the same time, the legitimate demand for such data creates a need for unencumbered, automated access. The competing preferences of securing such data and making such data readily obtainable to facilitate legitimate commercial and non-commercial activity must be balanced in order to preserve marketplace liquidity, prevent criminal activity and preserve privacy. The balancing of these competing preferences most often results in complex, nested governmental regulatory requirements. Complying with such regulatory requirements typically has a significant overhead cost and often inhibits the deployment of efficient processes.

For example, banks, credit issuers and collection agencies must have current information on consumers in order to profitably extend credit and collect on delinquent accounts. This data allows the issuers of credit to offer capital to individuals across the spectrum of risk. Relative to the collection of delinquent accounts, businesses use the traditional methods of skip tracing to gather information on consumers while attempting to comply with the constantly changing, complex regulations concerning the use of such information. In addition, the information obtained through these traditional methods is often incorrect or outdated because it typically originates through a third party data broker which aggregates such information from a limited number of sources.

It has long been known that the largest source of consumer information is other consumers. However, this is an extremely difficult source to tap. Collection and skip tracing agencies often attempt to contact neighbors or employers for consumer information with little or no success. These individuals, members of the general public, could earn revenue by providing timely data records to legitimate companies for legitimate purposes. However, the transfer of such data, being controlled by strict governmental regulation, makes it difficult to provide such data to legitimate users. Individuals either do not have a mechanism for connecting to the marketplace to sell their known data, or choose not to participate because of burdensome regulatory requirements and a general lack of expertise in data brokering.

In addition, there exists in the market a significant barrier to the aggregation of such data from such individuals. An entity which aggregates and resells such data may very well be categorized as a regulated entity under such regulatory schemes as the Fair Credit Reporting Act (FCRA). Thus, there are potentially significant barriers not only for the providers of such data, but for the brokers of such data. The regulations governing brokers of such data may often be more complex and difficult to comply with than the regulations governing the providers of such data. Therefore, data brokering entities typically must charge a premium for brokered data.

Systems where the general public can provide answers to proposed questions are known in the art today. However, there is no system that allows a member of the public to receive a payment for providing private data, such as consumer information, in a manner that complies with applicable privacy laws and regulations.

Therefore a need exists for method and system for gathering consumer information from members of the general public in a manner that maintains consumer privacy and assists user in complying with applicable laws and regulations.

### SUMMARY OF THE INVENTION

The present invention provides a methodology and system for facilitating the exchange of private data in a manner that assists the users in meeting the requirements of applicable regulatory schemes.

Advantageously, the invention provides an Exchange that is easily accessible to all members of the general public, allows individuals to earn revenue by providing known private data, such as consumer information, and reduces the costs of purchasing private data by streamlining the strict processes of compliance with applicable laws and regulations. The ease and accessibility of the exchange provides an incentive to individual providers of data who might be hesitant to sell data in the marketplace in spite of the fact that they might otherwise be legally permitted to do so. In addition, the Exchange provides previously unavailable and timely private data to data buyers with a legitimate business need.

One aspect of the current invention dramatically lowers the cost of such an information exchange, by providing a method whereby data providers and data buyers contractually agree to legally permissible uses of the exchanged private data, in a standardized framework. By reducing the complexity of complying with the nested regulatory schemes, the cost of commerce is reduced while data privacy is protected. Both data providers and data buyers may contractually agree to certain legal representations concerning the use and transmission of the data. Similar to a “click wrap” software license, the online agreements are legally binding contracts. These contractual legal representations allow the users to meet the requirements of the applicable government laws and regulations concerning the use and transmission of consumer information or other confidential data.

To ensure that the privacy of data is maintained, a strict process of data encryption and secure transmissions is provided by the present invention. In one exemplary embodiment, the Exchange entity never has access to the underlying consumer information. In addition to maintaining consumer privacy, this mitigates the risk that the Exchange entity will be categorized as a Fair Credit Reporting Act (FCRA) regulated entity, or otherwise be subject to regulatory schemes targeted at traditional data brokers.

Another aspect of the invention expands the universe of available private data, such as consumer information, by allowing individuals, which would not typically be able to find and negotiate with data buyers, to share their valuable data. The present invention also allows these individuals to earn revenue by the sharing of this information for legally permissible purposes.

The invention's effectiveness in gathering large amounts of previously unavailable private data is predicted by the “small world phenomenon,” a study of network behavior. For example, one small world hypothesis is that any person in the world can be reached through a short chain of social associations, with a median of six links, also known as the “six degrees of separation” hypothesis.

This concept was researched and presented by psychologist Stanley Milgram in the 1960's and by mathematician Duncan J. Watts in the 1990's. Duncan's research revealed that the small world phenomenon was common to a wide variety of networks, ranging from neurons to power grids. In particular, the World Wide Web, operating over the Internet, reacts as a small world network, showing a high degree of connectivity between a vast number of separate nodes, or Internet users. Therefore, each individual consumer on the Internet may provide known private data about a very large number of other consumers.

One exemplary embodiment of the present invention provides an online Exchange where a data buyer, such as a collection agency, may purchase consumer information for legally permissible purposes, such as collecting on a past-due account. In addition, a data provider, such as an individual living in a small town in the United States, may earn revenue by selling known consumer information, while remaining anonymous to the data buyer.

The foregoing has broadly outlined some of the aspects and features of the present invention, which should be construed to be merely illustrative of various potential applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

### BRIEF DESCRIPTION OF THE DRAWINGS

The accompanying drawings, which are incorporated in and constitute a part of this specification, illustrate embodiments of the invention, and together with the description, serve to explain the principles of the invention.

FIG. 1 is a context diagram for an Online Exchange Portal System constructed in accordance with an exemplary embodiment of the present invention.

FIG. 2A is a component diagram for an Online Exchange Portal System of FIG. 1.

FIG. 2B is a hierarchical chart of the data classification schema for Private Data.

FIG. 3 is a workflow diagram for a “Registration Procedure” of an exemplary embodiment of the present invention.

FIG. 4 is a workflow diagram for a “Creation of Data Requests” process of an exemplary embodiment of the present invention.

FIG. 5 is a workflow diagram for a “Selling Data” process of an exemplary embodiment of the present invention.

FIG. 6 is a workflow diagram for a “Settlement” process of an exemplary embodiment of the present invention.

FIG. 7 is a workflow diagram for a “Skip Tracing Workflow of Data Buyer” process of an exemplary embodiment of the present invention.

FIG. 8 is a workflow diagram for a “Skip Tracing Workflow of Data Provider” process of an exemplary embodiment of the present invention.

### DETAILED DESCRIPTION OF THE EXEMPLARY EMBODIMENTS

As required, detailed embodiments of the present invention are disclosed herein. It will be understood that the disclosed embodiments are merely examples to illustrate aspects of the invention that may be embodied in various and alternative forms. The figures are not necessarily to scale or in a sequential order, and some features may be exaggerated or minimized to show details of particular Components. In other instances, well-known materials or methods have not been described in detail to avoid obscuring the present invention. Therefore, specific structural and functional details disclosed herein are not to be interpreted as limiting, but as a basis for the claims and for teaching one skilled in the art to variously employ the present invention.

As used in the description herein and attachments hereto, the meaning of “a,” “an,” and “the” includes plural reference unless the context clearly dictates otherwise. Also, as used in the description herein and attachments hereto, the meaning of “in” includes “in” and “on” unless the context clearly dictates otherwise. Finally, as used in the description herein and attachments hereto, the meanings of “and” and “or” include both the conjunctive and disjunctive and may be used interchangeably unless the context clearly dictates otherwise. Defined terms carry the stated definitions whether expressed as nouns, verbs, adjectives or any other grammatical variation, throughout the specification and claims.

Further, although process steps, method steps, systems or the like may be described in a sequential order, such processes, methods and systems may be configured to work in alternate orders. In other words, any sequence or order of steps that may be described does not necessarily indicate a requirement that the steps be performed in that order. The steps of processes described herein may be performed individually or in any order practical. Further, some steps may be performed simultaneously.

It will be readily apparent that the various methods and systems described herein may be implemented by, e.g., appropriately programmed General Purpose Computing Devices. Typically a processor (e.g., a microprocessor) will receive instructions from a memory or like device, and execute those instructions, thereby performing a process defined by those instructions. Further, sets of instructions that implement such methods and algorithms may be stored as programs and transmitted using a variety of known media.

The data exchange of certain embodiments of the present invention can be implemented in hardware, software or a combination thereof. In one exemplary embodiment, the data exchange is implemented in software or firmware that is stored in a memory or computer readable medium, and that is executed by a suitable instruction execution system. If implemented in hardware, as in an alternative embodiment, the data exchange can be implemented with any technology, which is known in the art.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor, and the like. Transmission media may include or convey acoustic waves, light waves and electromagnetic emissions, such as those generated during radio frequency (RF) and infrared (IR) data communications, or any other wireless form of communication. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Where databases are described, it will be understood by one of ordinary skill in the art that (i) alternative database structures to those described may be readily employed; (ii) other memory structures besides databases may be readily employed.

Devices that are in communication with each other need not be in continuous communication with each other, unless expressly specified otherwise. In addition, devices that are in communication with each other may communicate directly or indirectly through one or more intermediaries. Additionally, a description of an embodiment with several Components in communication with each other does not imply that all such Components are required. On the contrary a variety of optional Components are described to illustrate the wide variety of possible embodiments of the present invention.

Data Definitions

Consumer Information—Identification information, demographic information, financial information, and other information related to personally identifiable individuals.
Data Buyer I.D. Code—A unique identifier assigned by the Online Portal System for each Data Buyer.
Data Provider Rating—A numeric rating of a Data Provider, submitted by a Data Buyer after each completed transaction. The numeric rating may reflect the number of accurate data submitted by that Data Provider. For example, the numeric rating may have a range of one to five, where five is earned by a Data Provider having five or more validated data submissions. The present invention may use to Data Provider Rating to determine the pay scale or pay schedule for that Data Provider.
Data Request—A submission from a Data Buyer, stating the data requested and providing as many identifying parameters as possible.
Demographic Data—Data describing a Data Provider, such as geographic, employment and age information. Demographic Data may be used to sort Data Requests for each Data Provider.
Legal Representations—A statement of a fact as of a certain time which may or may not have constraints on its duration and applicability, made by one party to another as a term of a particular Transaction, such that the party receiving the Legal Representation can contractually rely on it to take some action.
Private Data—Information protected by law from public access.
Record Type—A classification of a set of data elements, such as the classifications employment data, address data, and telephone data.
Registration Metric—A measurement of one registration criteria, such as business licensure, association membership and Demographic Data.
Standard Data Format—A set of rules which defines the type, format and other meta-characteristics of sets of data.
   System Definitions
Communications Network—A set of nodes which can transmit or receive messages over a communications medium using a standardized network protocol.
Communications Session—A connection over a Communications Network between mutually Authenticated Peers.
Component—Individual computing processes designed to perform a particular function or set of functions by receiving inputs of data and producing outputs of data.
General Purpose Computing Device—A device comprising a processor, such as a microprocessor, that receives instructions from a memory device and executes those instructions, thereby performing a process defined by those instructions and producing an output of data.
Portal Database—A database connected to the Portal System Software Application, used to store system data such as Registration Metrics and transaction data.
Portal System Software Application—A set of Components which permits the user of the Application to participate in an anonymous exchange of data.
   File Transfer Component—A computing process that transmits and receives sets of data records stored in a memory device as a file.
   Kernel Component—A computing process that manages and connects other Components and engines.
   Messaging Component—A computing process that creates and distributes alerts, such as emails.
   Registration Component—A computing process that approves users for participation in the Anonymous Exchange based on pre-determined criteria.
   Search Component—A computing process that compares Queries to Indices to determine whether matching data exists.
   Settlement Component—A computing process that manages the accounting for successful Transactions based on the Record Type transmitted and the price associated with that Record Type.
   User Interface—A computing process with a graphical display to allow users to interact with the Anonymous Exchange.
Settlement—The process of the requesting party of a Transaction delivering the requisite payment to the responding party of a Transaction.
Transaction—The process of one party requesting a particular set of data and another party delivering the particular set of data to the requesting party.
   System Users Definitions
System Administrator—Entity that initiates and maintains an instance of the Online Portal Exchange System.
Data Buyer—Entity, whose registration has been approved by the Online Portal Exchange System, seeking to purchase Private Data from Data Providers that matches submitted Data Buyer Queries.
Data Provider—Entity, whose registration has been approved by the Online Portal Exchange System, seeking to earn revenue by selling Private Data to Data Buyers.

Those skilled in the art will also appreciate that the system and method described herein represent only one example of the various configurations that will be suitable for implementation of the various embodiments of the invention. Accordingly, the scope of the present invention is described by the claims appended hereto and supported by the foregoing.

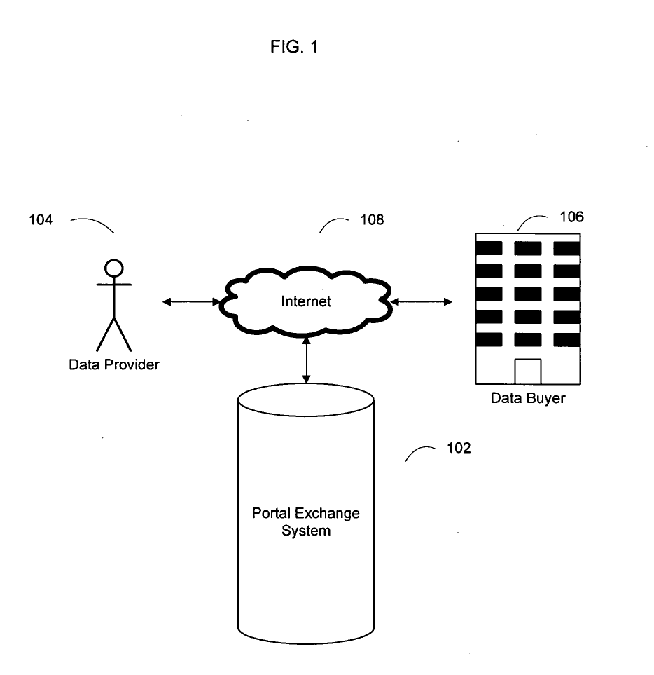

FIG. 1 depicts one exemplary embodiment of an Online Portal Exchange System 102, shown communicating with a Data Provider 104 and a Data Buyer 106 over the Internet 108. In alternative embodiments, the Internet 108 may be any communication method or network. In addition, the Portal System 102 may be any computational system to facilitate the exchange between the Data Provider 104 and the Data Buyer 106.

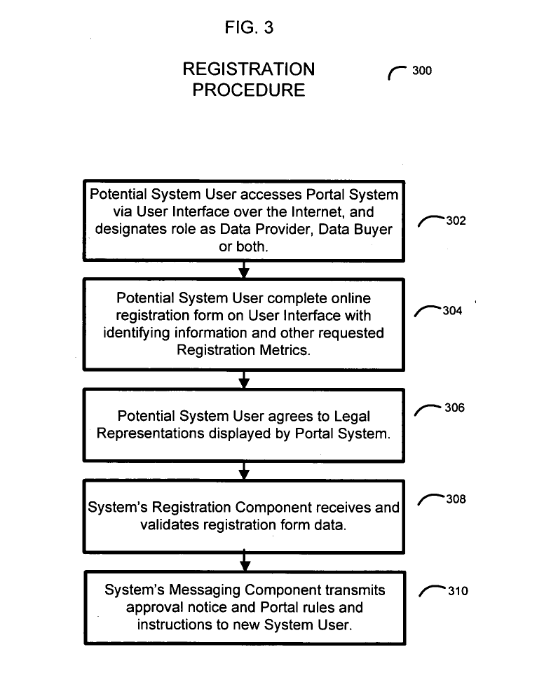

The Data Provider 104 may be any entity owning, or with knowledge of, Private Data, such as a member of the general public with personal knowledge of current Consumer Information. The Data Buyer 106 may be any entity seeking to purchase Consumer Information or other Private Data for a legally permissible purpose. For example, the Data Buyer may be a collection agency, collecting on debts on behalf of a third party. Therefore, the Data Buyer may have a legitimate business purpose, according to applicable laws and regulations such as the Gramm-Leach-Bliley Act (GLBA), to access data that is provided by a Data Provider 104. Once registered, as discussed in more detail with reference to FIG. 3, the Data Provider 104 and the Data Buyer 106 are System Users of the Online Portal Exchange System 102. All potential and registered System users need only utilize a General Purpose Computing Device to interact with the Portal System 102.

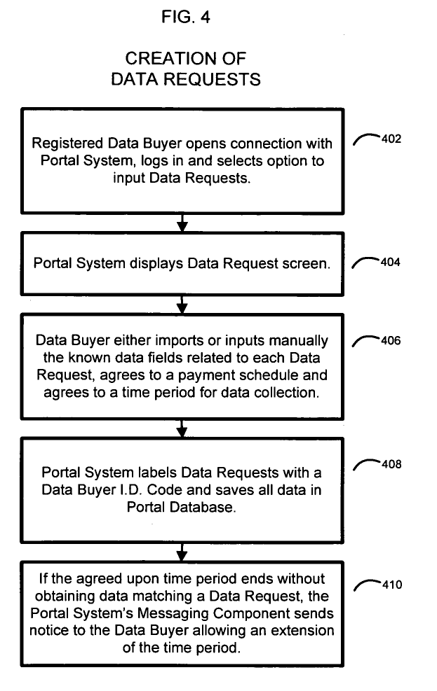

The present invention may provide businesses with access to a previously unavailable source of Consumer Information, being the general public. There is a theory of network behavior known as the “small world phenomenon.” One aspect of the small world theory predicts that every network of separate nodes will result in a high degree of connectivity. For example, based on small world experiments, as referenced in the Summary portion of this patent application, any person on the planet is said to be connected to every other person by six steps, called the “six degrees of separation” hypothesis. Therefore, one may extrapolate that every individual consumer on the World Wide Web may provide known Private Data about a large number of other consumers. The present invention takes advantage of this network behavior to locate previously unavailable data. As will be discussed in more detail with reference to FIG. 4, a Data Buyer 106 may submit a Data Request, which the Portal Exchange System displays to a Data Provider 104.

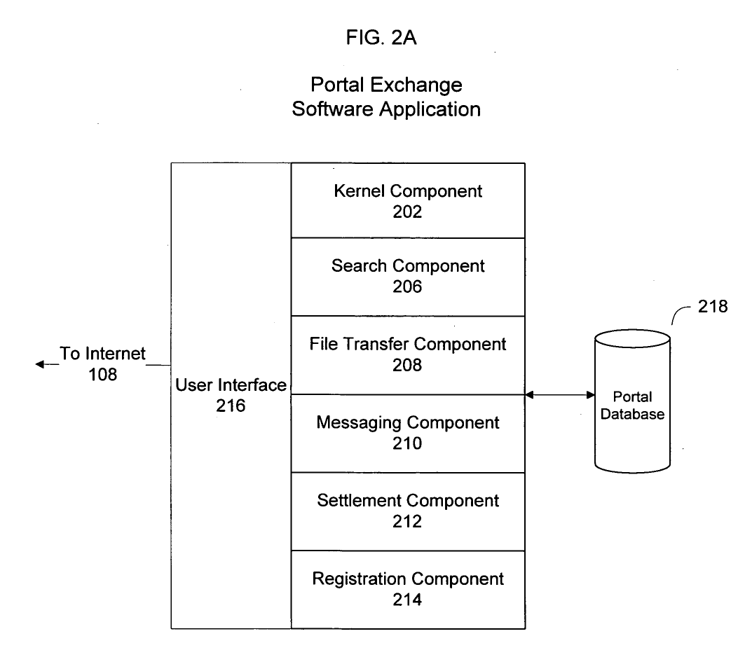

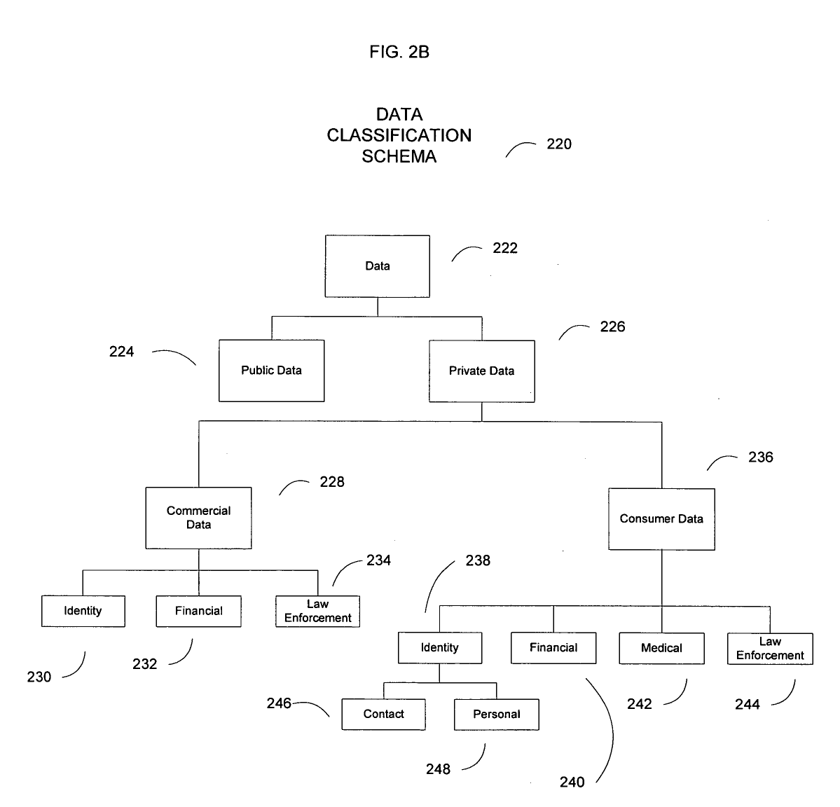

FIG. 2A depicts a component diagram 200 for one exemplary embodiment of the Online Portal Exchange System 102 of FIG. 1. The Portal Exchange Software Application may include a plurality of functional Components, including a Search Component 206, a File Transfer Component 208, a Messenger Component 210, a Settlement Component 212, and a Registration Component 214. Components 206-214 are all accessible to a System User via a User Interface 216, and may be managed by a Kernel Component 202. The Online Portal Exchange System may also utilize a Portal Database 218, to hold all system and transaction data. The Portal Database 218 may store Transaction data, Settlement data, Data Requests, Data Provider Ratings, Demographic Data, and the like. In alternative embodiments, the Online Portal System may also store the Private Data collected from the Data Providers, then acting as a data broker, with the ability to provide data directly to third party Data Buyers. In further alternative embodiments, the Online Portal System Software Application may comprise any other computing system or collection of systems that performs the functions of the present inventive method.

FIG. 2B presents a Data Classification Schema 220 for Private Data 226, as related to the present invention. The general classification of data 222 is here broken into public data 224 and Private Data 226. Private Data 226, as utilized by the exemplary embodiments of the invention, is defined as data that is not publicly known, or not known to a Data Buyer. The present invention provides a method and system that may facilitate the exchange of Private Data 226 in a manner that allows Data Buyers and Data Providers to comply with the applicable laws and regulations that protect the Private Data 226.

Private Data 226 is broken into commercial data 228, being data concerning business entities, and consumer data 236, being data about individual consumers. Consumer data 236, commonly referred to as Consumer Information, may be broken into at least four sub-categories, identity 238, financial 240, medical 242 and law enforcement 244. Identity data 238 may be further broken into contact data 246, being contact information such as address and telephone numbers, and personal data 248, being data to identify the exact individual, such as a social security number. The exemplary embodiments of this Detailed Description deal with the exchange of Consumer Data 236. In alternative embodiments, the present invention, harnessing the small world phenomenon of network behavior, may be utilized to facilitate the exchange of any type of data.

FIG. 3 depicts a process diagram 300 for the Registration of potential System Users. In this exemplary embodiment, every System User must first register with the Portal System in order to participate in the Exchange. In step 302, each potential System User accesses the Portal System via the User Interface Component, over the Internet. The System User may designate their desired role on the Portal Exchange System as a Data Provider, a Data Buyer, or both.

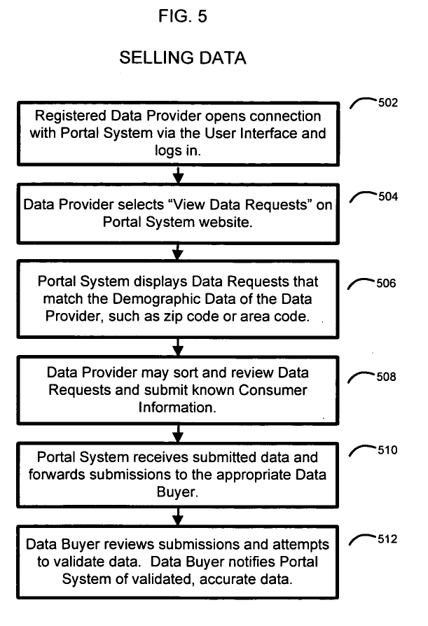

The potential System User completes in step 304 an online registration form, displayed on the User Interface, by submitting identification information and other requested Registration Metrics. In particular, the Registration Metrics may include Demographic Information, such as geographic location, age, schools attended and the like. The Demographic Information may be utilized to sort information for the Data Providers, as will be discussed in more detail with reference to FIG. 5. In alternative embodiments, the Registration Metrics may include any other data that may be utilized for sorting the Data Requests to be displayed to the Data Providers.

As part of the registration process, all potential System Users must also agree in step 306 to Legal Representations displayed on the User Interface by the Portal System. The Legal Representation, as discussed above, may be a written agreement, in electronic format, whereby the parties contractually agree to at least one legally permissible purpose for the use of the Private Data, to the extent required by applicable law, such as compliance with the Gramm-Leach-Bliley Act, other rules concerning the exchange of consumer or commercial information, or the like.

Once the Portal System receives the registration form data in step 308, it may begin a validation process. The System may validate the identity or other submitted data about the potential System User. Validation may include comparing the potential System User's data with data from credit bureaus, industry association or other third party entities.

In this exemplary embodiment, after System User is validated and approved by Portal System, the System's Messaging Component transmits in step 310 an approval notice, along with a set of Portal rules and instructions, to the new System User. In alternative embodiments, System Users may be allowed to participate without a registration or validation process. Alternatively, a System User may be required to submit registration data later in the process, such as upon the initiation of a transaction, or register through a third party entity.

FIGS. 4-6 are Workflow Diagrams from the Point of View of the Online Portal System:

FIG. 4 depicts a process diagram 400 for an exemplary Creation of Data Requests process for the present invention. In step 402, a Registered Data Buyer opens a connection with the Portal System over the Internet, logs in and selects the option to input a Data Request. The Portal System Software Application displays the Data Request screen on the User Interface, as step 404.

To submit a Data Request, the Data Buyer may either import, such as a batch upload, or manually input in step 406 the known data fields related to each Data Request. For example, if the Data Buyer is seeking a current telephone number for a consumer, the Data Buyer would input the name, last known address, and other such. identifying information about the consumer. To submit the Data Request, the Data Buyer may also be required in step 406 to agree to a certain payment schedule and time period. The time period may limit how long the Data Request is displayed on the Portal site. For example, the Data Buyer may agree to a time period of three months for the posting of a Data Request on the Portal System. In alternative embodiments, any method of file transmission may be utilized in submitting a Data Request, such as FTP, web services, or the like.

In step 408, the Portal System labels a submitted Data Request with a Data Buyer I.D. Code, as assigned by the Portal System, and stores the Data Request in the Portal Database. If the agreed upon time period for the Data Request ends in step 410 without the submission of matching data by a Data Provider, the Portal System's Messaging Component sends, also in step 410, a notice to the Data Buyer. The notice may allow the Data Buyer to select and extension of time for the Data Request, or may require that the Data Request be resubmitted.

FIG. 5 depicts a process diagram 500 for a Selling Data process of the exemplary embodiment of the present invention. A Registered Data Provider opens a connection in step 502 with the Portal System via the User Interface and logs in. The Data Provider selects in step 504 “View Data Requests” on the Portal System webpage. The Portal System sorts the Data Requests based on a dimensional filter and displays in step 506 the Data Requests that match the Demographic Data of that particular Data Provider, such as zip code, area code, employment or the like. In alternative embodiments, in addition to, or in place of, Demographic Data, the Portal System may display the Data Requests according to a random queue or a weighted queue. In a weighted queue, for example, a Data Buyer may be allowed to pay an extra fee to give priority to a certain Data Request. Alternatively, a Data Provider may be allowed to list or bid on how much they would pay for certain Data Requests. In a broader alternative embodiment, a Data Provider may be given the ability to view and sort all pending Data Requests.

In step 508, the Data Provider may sort and review the displayed Data Requests and may submit known private data, such as Consumer Information, in response to one or more Data Request. The data privacy is maintained by the use of a security methodology, such as data encryption. For example, the parties may communicate with the Portal System over Secure Sockets Layer (SSL) linkage, or utilize PGP encryption or the like. Alternatively, the Portal System may authenticate System User log-in utilizing Public Key Infrastruction (PKI) and digital certificates.

The Portal receives in step 510 the submitted data and forwards the submissions to the appropriate Data Buyer, based on the Data Buyer I.D. Code attached to each Data Request. The Portal may also assign and attach a Data Provider I.D. code to each Data Request. As discussed previously, in alternative embodiments the Exchange entity, acting as a Data Broker, may collect and aggregate the Private Data. For example, the Portal System may store data submissions from Data Providers and sell this data directly to Data Buyers. In that case, the Data Provider may receive a royalty fee each time their submitted data is sold to a Data Buyer. Applicant hereby incorporates by reference a related U.S. patent application Ser. No. 11/145,153, entitled “System and Method for a Peer to Peer Exchange of Financial Information,” filed with the U.S. Patent & Trademark Office on Jun. 3, 2005. This application discloses a method and system to facilitate the exchange of Consumer Information by providing a secure Peer-to-Peer commerce network allowing Peers to directly exchange data, such as Consumer Information, in an efficient and economic manner, in compliance with applicable laws.

A Data Buyer reviews the submitted data in step 512 and attempts to validate the data. If the data is found to be accurate, the Data Buyer will notify, also in step 512, the Portal System of the accuracy of the data. If the data validation fails, the Data Buyer will notify the Portal System, which will in turn notify the Data Provider. In this exemplary embodiment, the Data Buyer may be required to pay before receiving the data if the Data Provider has attained a high enough Data Provider Rating. For example, a Data Provider with five or more validated data submissions may then earn a Rating of five points, and earn the right to be paid for all data submitted, at the time of submission. However, future inaccurate data submissions may lower the Rating below five points, in which case the Data Provider would again only be paid after the Data Buyer has validated the data submission. If the Data Provider only gets paid for validated submissions, the Portal System may provide a feedback mechanism to allow Data Providers to report a Data Buyer who claims it could not validate good data. The Portal System may require the ability to mediate disputes or even banish System User. In alternative embodiments, the payment could be based on any agreed upon schedule or requirement.

If multiple data submissions are received by a Data Buyer for one Data Request, the Portal System allows the Data Buyer to view details on the Data Provider, such as Data Provider Rating, total number of validated responses, percentage of validate responses, area of expertise, and the like. The Data Buyer may then choose to purchase one or all of the submissions. Alternatively, the Data Buyer may choose a set of responses and then pay for all that can be validated.

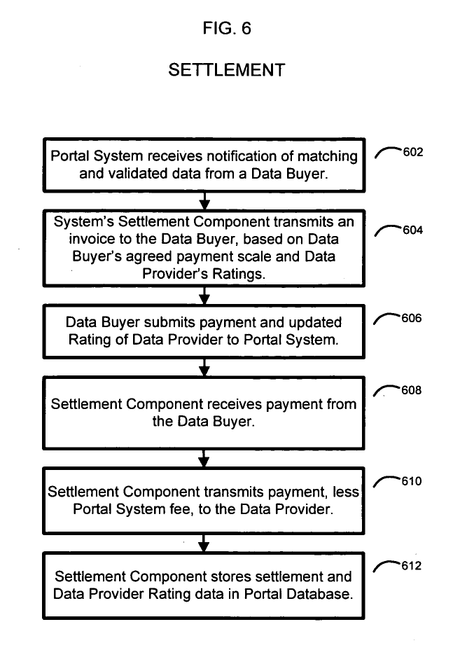

FIG. 6 depicts a process diagram 600 for a Settlement process of the exemplary embodiment of the present invention. The Portal System receives in step 602 notification of validation of the submitted data from a Data Buyer. The Settlement Component of the Portal System transmits an invoice in step 604 to the Data Buyer, based on the Data Buyer's agreed upon payment scale and the Data Provider's Rating. For example, a Data Provider with a higher Rating may be entitled to a higher price. In alternative embodiments, the higher Rating may entitle a Data Provider to be paid earlier in the process, such as before validation.

The Data Buyer submits the payment in step 606, as listed on the invoice. In this exemplary embodiment, the Data Buyer electronically transfers the payment amount from a designated account. The Data Buyer updates in step 606 the Rating of the Data Provider. The Data Buyer will increase the Rating of the Data Provider if the submitted data was timely and validated as accurate. In alternative embodiments, the Portal System itself could manage the Rating of the Data Providers, or the System may operate without Ratings of System Users.

The Settlement Component of the Portal System receives in step 608 the payment from the Data Buyer. The Settlement Component transmits the payment amount, less the Portal System fee, to the appropriate Data Buyer in step 610. The Settlement Component stores the settlement and Ratings data in the Portal Database. In alternative embodiments, the payment process may be handled by a third party entity, any electronic debit and credit system, or any such computing or manual process. In addition, the System data may be stored in any database or in any component or system of components that allows for the retrieval of data.

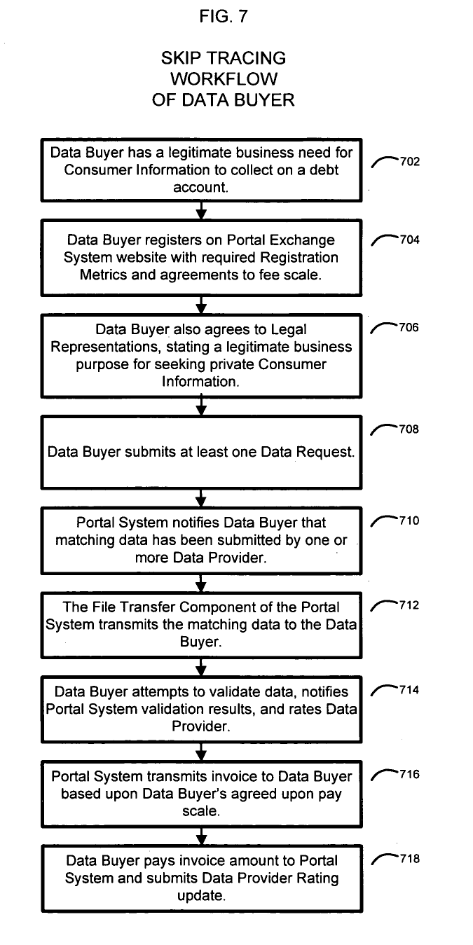

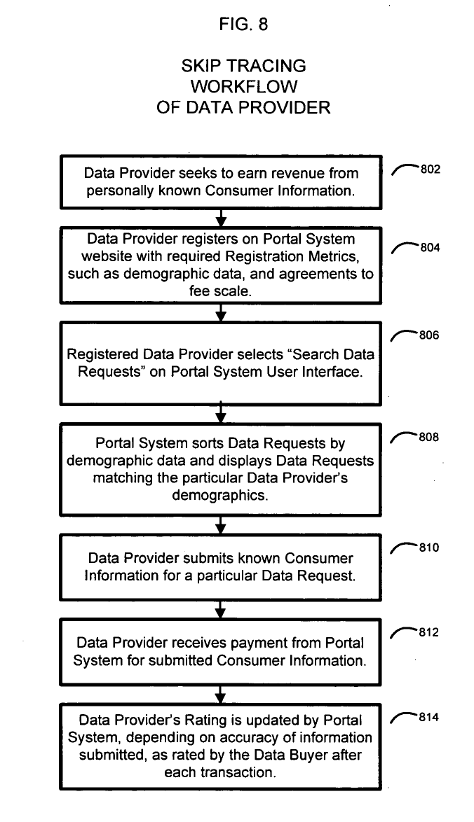

FIGS. 7 and 8 are Workflow Diagrams from the Point of View of System Users:

FIG. 7 depicts a workflow diagram 700 of an exemplary Skip Tracing Workflow of a Data Buyer. The process 700 begins with a Data Buyer having in step 702 a legitimate business need for a particular piece of Consumer Information, such as to collect on a debt account. In the context of this exemplary embodiment, a legitimate need is one that serves a legal business purpose, and would be in compliance with the applicable laws and regulations protecting Private Data.

In this exemplary embodiment, the Data Buyer must register on the Portal System website in step 704 by submitting the requisite Registration Metrics and agreements to the Portal rules, such as a fee scale. The Registration Metrics may include identification data, company data, industry association membership data and the like.

As part of the Registration process, the Data Buyer must also agree in step 706 to certain Legal Representations, such as stating a legitimate business purpose for seeking private Consumer Information, in compliance with applicable laws and regulations. As discussed above, with reference to FIG. 3, the agreement to the Legal Representations is a binding contract to ensure the proper handling of Private Data. In alternative embodiments, the agreement to Legal Representations may be part of the purchasing process, Data Request process or the like, rather than being a requirement of Registration.

A registered Data Buyer may submit in step 708 at least one Data Request. The Data Request is a request for a specific piece of data. In this exemplary embodiment, the Data Request is a request for a piece of Consumer Information, identified by known information about the same consumer. For example, if the Data Buyer is a collection agency seeking the most recent address of a consumer, the Data Buyer may submit the name and previous address of the consumer and possibly other related information, along with the Request for certain other information, such as telephone number, current address or the like. The related parameter data will allow a Data Provider to identify the consumer in question in order to provide the requested data.

When a Data Provider submits data in response to a Data Request, the Messaging Component of the Portal System will notify the Data Buyer in step 710. The Portal System attaches a Data Provider I.D. Code to the submitted data. The File Transfer Component of the Portal System may transmit the matching data to the appropriate Data Buyer. In alternative embodiments, the Data Buyer may log in to the Portal System and download the submitted data.

Data Buyer attempts to validate in step 714 data, notifies Portal System of validation results, and submits an updated Rating on the Data Provider. In this exemplary embodiment, the Data Buyer does not have to pay for the data until it has been validated. If the data validation fails, the Data Buyer notifies the Portal System and the Portal System notifies the Data Provider. As discussed previously, depending on the Data Provider Rating, the Data Buyer may not have to pay for inaccurate data. The Data Buyer rates in step 714 each Data Provider based on the accuracy of the data submitted by that Data Provider. The Data Provider's Rating may determine when the Data Provider will receive payment for the next submission of accurate data. For example, a Data Provider with a Rating over a certain set amount may qualify to be paid immediately by the Data Buyer, before the Data Buyer can receive and validate the data. In alternative embodiments, any Rating system, combination of Rating systems or no Rating system may be utilized in the present invention. As discussed with respect to FIG. 5, a Data Buyer may receive multiple submissions in response to a particular Data Request. The Data Buyer may view all data submissions and may choose all, none or a subset, based upon the data listed concerning each Data Provider. For example, a Data Buyer may choose data submissions from a Data Provider that only earns a fee for validated data, or may choose a data submission from a Data Provider with a higher than ninety percent accuracy history.

If Data Buyer acknowledges any accurate, validated data, the Portal System transmits in step 716 an invoice to the Data Buyer, based on the agreed upon pay scale. In alternative embodiments, the amount of the payment may also be based on the Data Provider's Rating. The Portal System may set a flag on a fulfilled Data Request, in the Portal Database, to ensure that it is on longer displayed to potential Data Providers. Alternatively, a Data Buyer could select to have a Data Request persist, in order to gather more information concerning that Data Request.

The Data Buyer pays in step 718 the invoice amount to the Portal System and submits an update to the Data Provider's Portal Rating. The Portal System may accept any form of payment or may have a third party system handle payment transactions. In this exemplary embodiment, the Portal System retains a percentage or set amount of the payment as a service or licensing fee. In alternative embodiments, any payment arrangement may be implemented that allows a Data Buyer to be compensated for a submission of data.

FIG. 8 depicts a workflow diagram 800 of a Skip Tracing Workflow of a Data Provider. In this exemplary embodiment, a Data Provider is seeking in step 802 to earn revenue from personally known Consumer Information. The Data Provider registers on the Portal System website in step 804, via the User Interface, and submits 804 the required Registration Metrics. The Metrics may be identification data, demographic data, and agreements to the Portal System terms and conditions, such as fee scale, time frames, confidentiality and the like.

The registered Data Provider may select in step 806 to “Search Data Requests” on the Portal System User Interface. In step 808, the Portal System sorts all collected Data Requests, by demographic data parameters, and displays the Data Requests that match the particular Data Provider's demographic data on the User Interface. In alternative embodiments of the present invention, any method of displaying Data Requests to a Data Provider may be utilized.

If the Data Provider has known Consumer Information, or other such data, to answer a particular Data Request, the Data Provider may submit in step 810 the data to the Portal System. The data may be submitted through the User Interface, via the File Transfer Component, or by any other means of transmitting data.

In this exemplary embodiment, the Data Provider receives in step 812 the payment from the Portal System for each data record submitted. For example, the Portal System will notify the Data Buyer of data submitted in response to a particular Data Request. The Data Buyer submits a payment in order to receive the data. In alternative embodiments, the Data Buyer may be allowed to validate the data first and only pay for data proven accurate. Alternatively, the Portal System or a third party entity may be responsible for validating submitted data. Any form of payment may be utilized by the present invention, such as third party payment systems, online accounts, and the like.

At the end of the transaction, the Data Buyer will update in step 814 the Rating, or ranking, of the Data Provider, by submitting a Rating for the most recent transaction to the Portal System. As discussed previously, the Rating of the Data Provider may determine the timing and the amount of the Data Provider's payment.

In alternative embodiments, the Portal System of the present invention may be embodied in multiple online entities or may be embodied fully or partially in software that is distributed to the Data Providers and Data Buyers; or partially in software that is distributed to the System Users and operative as a peer-to-peer arrangement. Additionally, the present invention may be implemented over any Communications Network, including telephonic or wireless systems.

Alternatively, embodiments of the present invention may utilize any type of encryption or secure messaging processes, manual or automatic, internal or external, now known or to be invented, to ensure the data confidentiality and data integrity.

The present invention has been illustrated in relation to embodiments which are intended in all respects to be illustrative rather than restrictive. Those skilled in the art will recognize that the present invention is capable of many modifications and variations without departing from the scope of the invention.

Those skilled in the art will also appreciate that the system and method described represents only one example of the various configurations that will be suitable for implementation of the various embodiments of the invention. Accordingly, the scope of the present invention is described by the claims appended hereto and supported by the foregoing.

What is claimed is:

1. A computer-implemented method for exchanging private data, comprising the steps of:
receiving at an on-line exchange a data request from at least one data buyer, each data buyer operating as a purchaser of the private data, the data request defining a request for at least a portion of the private data;
publishing at the on-line exchange at least a portion of the data request, the published portion comprising information useful for identifying the subject of the private data portion;
receiving at the on-line exchange a communication from a data provider, the communication advising that the data provider has information relevant to the data request portion published by the on-line exchange, the data provider having knowledge of the subject of the private data portion in a manner predicted by “small world” network behavior theory;
arranging for the data provide and the data buyer to exchange the private data portion via the on-line exchange while maintaining both the anonymity of the data provider and the data buyer and the security of the private data.

2. The computer-implemented method of claim 1 further comprising the step of arranging at the on-line exchange for a payment as compensation for delivery of the selected portion of the private data by the at least one data provider to the data buyer seeking the selected private data portion.

3. The computer-implemented method recited by claim 1, wherein the private data comprises one of identification information, demographic information and financial information, each associated with a personally identifiable individual or entity.

4. The computer-implemented method recited by claim 1 further comprising the step of requiring the data buyer to consent to legal requirements for obtaining the private data, the legal requirements comprising a legal representation presenting a statement of fact as of a certain time made by the data buyer and governing the terms for the data request, wherein the other party can contractually rely on the statement by the data buyer.

5. The computer-implemented method recited by claim 1, further comprising the step of registering the data provider and the data buyer at the on-line exchange, where the data provider registers to operate as a source of the private data and the data buyer registers to operate as a purchaser of the private data in a manner consistent with legal requirements for obtaining the private data.

6. The computer-implemented method recited by claim 5, wherein the step of registering data provider and data buyer comprises the steps of:
for each of the data provider and the data buyer, completing registration form data for an on-line registration form;
validating the registration form data;
identifying the data provider and the data buyer associated with the completion of a successful validation as a registered data provider and a registered data buyer.

7. The computer-implemented method recited by claim 6 further comprising the step of requiring each data buyer to consent to the legal requirements for obtaining the private data as part of the completion of the registration form data for the on-line registration form.

8. The computer implemented method recited by claim 7, wherein the legal requirements comprise a legal representation comprising a legally binding agreement governing use of the private data by each of the data buyers.

9. The computer implemented method recited by claim 1 further comprising the step of assigning the data request an identifying code uniquely associated with the data buyer.

10. A computer-implemented method for exchanging private data comprising consumer data, comprising the steps of:
receiving at an on-line exchange a data request from one of a plurality of data buyers, the defining a request for a selected portion of the consumer data, each data buyer consenting to a legal representation governing the terms of use for the consumer data;
responsive to the data request, publishing at the on-line exchange information descriptive of the subject matter of the selected portion of the consumer data desired by the data buyer;
responsive to publication of the descriptive information, receiving at the on-line exchange the selected portion of the consumer data from one of a plurality data providers, each data provider independently operating as a source of private data;
forwarding to the data buyer the selected portion of the consumer information received from the data provider to complete a secure exchange of the selected portion of the consumer data while maintaining the anonymity of the data provider and the data buyer.

11. The computer-implemented method of claim 10 further comprising the step of arranging at the on-line exchange for a payment as compensation for delivery of the selected portion of the consumer data by the data provider to the data buyer seeking the selected consumer data portion.

12. The computer-implemented method recited by claim 10, wherein the consumer data comprises one of identification information, demographic information and financial information, each associated with a personally identifiable individual or entity.

13. The computer-implemented method recited by claim 10, wherein the legal representation comprises a statement as of a certain time made by one of the data buyers and governing the terms for the data request, wherein the other party can contractually rely on the statement by the data buyer.

14. The computer-implemented method recited by claim 10, further comprising the step of registering the data providers and the data buyers at the on-line exchange, comprising the steps of:
for each of the data providers and the data buyers, completing registration form data for an on-line registration form;
for each of the data buyers, requiring consent to legal requirements for obtaining the consumer data as part of the completion of the registration form data;
validating the registration form data;
identifying each of the data providers and the data buyers associated with the completion of a successful validation as registered data providers and registered data buyers.

15. A system operative for exchanging consumer data, comprising:
a plurality of data buyer computers, coupled to a distributed computer network, each operative to transmit a data request via a distributed computer network, the data request defining a request for at least a portion of the consumer data;
a plurality of data provider computers, coupled to the distributed computer network, each operative as a potential source of the consumer data as predicted by “small world” network behavior theory; and
an on-line exchange coupled to the distributed computer network,
the on-line exchange, responsive to receipt of one of the requests issued by one of data buyer computers, operative to publish at least a portion of the data request comprising information useful for identifying a subject of the portion of consumer data,
wherein the on-line exchange, responsive to a communication transmitted by one of the data provider computers, the communication advising that the data provider has information relevant to the data request portion published by the on-line exchange, operative to manage a data exchange operation for the data provider computer and the data buyer computer in support of an exchange of the portion of the consumer data while maintaining the anonymity of the data provider computer and the data buyer computer.

16. The system of claim 15 wherein the on-line exchange is further operative to arrange for a payment to the at least one data provider computer as compensation for completing delivery of the portion of the consumer data to the data buyer computer associated with the data request.

17. The system of claim 16, wherein each of the data provider computers and the data buyer computers are operative to register for operations at the on-line exchange.

18. The system of claim 17, wherein each of the data buyer computers are further operative to consent to legal requirements for obtaining and exploiting the consumer data in advance of completion of the data exchange operation managed by the on-line exchange.

19. A system operative for exchanging consumer data among a plurality of data buyer computers associated with data buyers seeking to purchase items of the consumer data and a plurality of data provider computers associated with data providers serving as a potential source of the consumer data in a manner predicted by “small world” network behavior theory, comprising:
an on-line exchange, responsive to receipt of one of the requests issued by one of data buyer computers, operative to publish at least a portion of the data request comprising information useful for identifying a subject of the portion of consumer data,
wherein the on-line exchange, responsive to a communication transmitted by one of the data provider computers, the communication advising that the data provider computer has information relevant to the data request portion published by the on-line exchange, operative to manage a data exchange operation for the data provider computer and the data buyer computer in support of an exchange of the portion of the consumer data.

20. The system of claim 19 wherein the on-line exchange is further operative to arrange for a payment to the data provider computer as compensation for completing delivery of the one or more items of the consumer data to the data buyer computer associated with the data request.

21. The system of claim 19, wherein each of the data provider computers and the data buyer computers are operative to register for operations at the on-line exchange in advance of the data exchange operation.

22. The system of claim 21, wherein each of the data buyer computers are further operative to consent to legal requirements for obtaining and exploiting the consumer data in advance of completion of the data exchange operation managed by the on-line exchange.
